(19) United States
(12) Patent Application Publication
(10) Pub. No.: US 2013/0202146 A1
(43) Pub. Date: Aug. 8, 2013

(54) ELECTRONIC APPARATUS WITH CONNECTION CABLE AND EARPHONE/EAR PLUG MANAGEMENT

(71) Applicant: Quan XUE, Hong Kong (HK)

(72) Inventor: Quan XUE, Hong Kong (HK)

(73) Assignee: CITY UNIVERSITY OF HONG KONG, Kowloon (HK)

(21) Appl. No.: 13/366,531

(22) Filed: Feb. 6, 2012

(51) Int. Cl. H04R 25/00

(52) U.S. Cl. 381/384

(57) ABSTRACT

There is provided an electronic apparatus having a main body, an ear phone and a connection cable with a substantial length for connecting the ear phone to the main body. The apparatus is provided with a device to releasably secure the earphone and/or the connection cable to the apparatus to minimize the connection cable from tangling up, and wherein the securing device has i) a mounting means having a surrounding wall defining a first cavity with a width slightly larger than the width of the connection cable for releasably mounting a section of the connection cable to the apparatus and/or ii) a recess for releasably securing the ear phone to the apparatus.

### FIELD OF THE INVENTION

The present invention is concerned with an electronic apparatus or system and in particular an electronic apparatus having an audio function and provided with a connection cable and earphone management.

### BACKGROUND OF THE INVENTION

Over the past twenty to thirty years, there have been numerous developments on electronic audio apparatus and systems, and in particular portable electronic audio apparatus and systems. In the 80's, “walkmans” were very popular although they were rather bulky and heavy such that carrying them around would be quite inconvenient. In the early 90's, compact disc players had taken over walkmans. Then in the late 90's, portable MP3 players had for a period of time become very popular. Nowadays, many cellular phones or portable digital devices are equipped with built-in functions of providing audio, e.g. outputting music, to an earphone through a connection cable. One feature that hasn't changed is that when using such electronic audio devices as music or audio players, a connection cable connected to the devices at one end and to an earphone at the other end is still often widely used.

The length of such connection cable is usually substantial such that the cable is long enough to extend from an earphone worn by a user by the ear and the electronic audio apparatus typically located in a pocket of a garment of the user or a bag carried by the user. One common problem is that when the apparatus is not in use, and the apparatus together with the connection cable is put away in a bag, the connection cable becomes easily tangled up. It is rather cumbersome and time-consuming trying to untangle the connection cable. Further, seeking to untangle the connection cable in a rush might even damage the connection cable.

The present invention seeks to address this problem or to some extent to minimize the problem, or at least to provide an alternative to the public.

### SUMMARY OF THE INVENTION

According to an aspect of the present invention, there is provided an electronic apparatus comprising a main body, an ear phone and a connection cable with a substantial length for connecting the ear phone to the main body, wherein the apparatus further comprises a device to releasably secure the ear phone and/or the connection cable to the apparatus to minimize the connection cable from tangling up, and wherein the securing device includes i) a mounting means having a surrounding wall defining a first cavity with a width slightly larger than the width of the connection cable for releasably mounting a section of the connection cable to the apparatus and/or ii) a recess for releasably securing the ear phone to the apparatus.

Preferably, part of the surrounding wall may take the form of a flexible or resilient finger which, in use, is adapted to flex slightly to facilitate the section of the connection cable entering or exiting from the first cavity. The mounting means may, or may be alternatively, provided with a surrounding wall defining a second cavity with a width large enough to accommodate two sections of the connection cable. The first and second cavities may be adjacent each other and separated by a divider.

In an embodiment, the securing device may take the form of a C-shape structure, a notch-like structure or a slot structure. The structure may be protruded from a side of the apparatus. In an alternative embodiment, the structure may be recessed into a side of the apparatus.

In another embodiment, the securing device may be provided on a surface of the apparatus.

In one embodiment, the apparatus may further comprise a protective cover or a casing and the securing device may be provided on a surface of the cover or the casing.

Preferably, the recess of the structure may be sized and shaped to provide a tight fit to accommodate ends of the earphone for releasably securing the earphone to the apparatus. In one embodiment, the recess may be provided on a surface of the apparatus.

In a different embodiment, the apparatus may further comprise a cover or a casing and the securing device may be provided on a surface of the cover or the casing.

The recess of the structure may be configured to form an indentation or a cavitation provided on a rear surface of the apparatus.

### BRIEF DESCRIPTION OF DRAWINGS

Embodiments of the present invention are now described, by way of example only, with reference to the following drawing in which:

FIG. 1a is a schematic diagram showing a front view of an embodiment of the present invention in the form of a cellular phone;

FIG. 1b is a rear view of the cellular phone of FIG. 1a;

FIG. 2 is a schematic diagram showing a side view of an embodiment of the present invention also the form of a cellular phone;

FIGS. 3a to 3c are schematic diagrams showing three different manners a connection cable is secured to a cellular phone;

FIGS. 4 and 5 are schematic diagrams showing two different manners an earphone is secured to a cellular phone; and

FIG. 6 is a perspective schematic view showing an alternative device for use in securing a connection cable.

### DETAILED DESCRIPTION OF PREFERRED EMBODIMENTS OF THE INVENTION

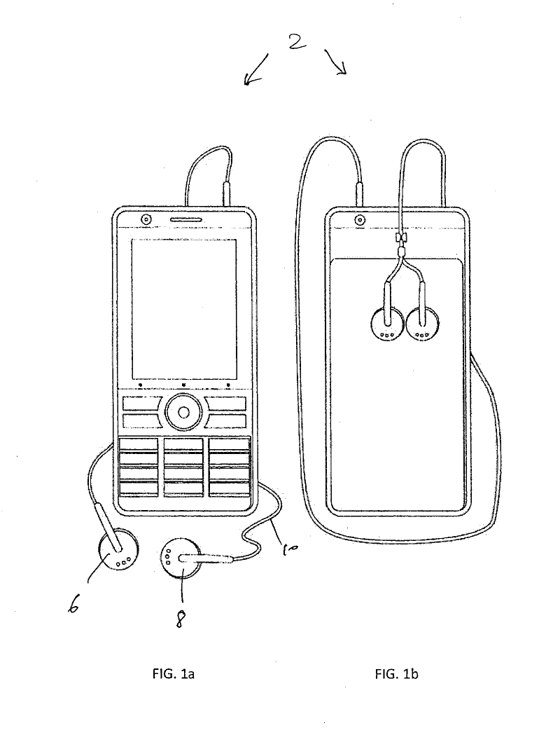

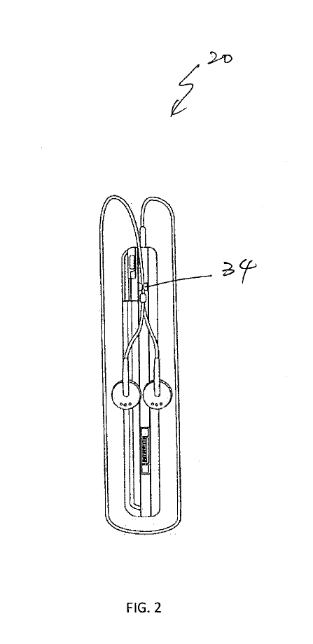

FIG. 1a is a schematic view showing an exemplary electronic apparatus, generally designated 2. The device is a cellular phone equipped with an audio function. The cellular phone is provided with an audio jack receiver located at an upper end of the phone 2. The apparatus 2 is also provided with an audio set 4 including a pair of earplugs 6, 8 and a connection cable 10 connecting the audio jack 4 and the earplugs 6, 8 such that electrical signals are transmitted from the apparatus 2 to the audio jack 4 and then to the earplugs 6, 8 via the connection cable 10. The connection cable 10 has a substantial length. It can be envisaged that the connection cable 10 would be easily tangled up, for example, when the apparatus 2 together with the connection cable 10 is put in a backpack.

The apparatus 2 is provided with a device 12 for releasably securing the connection cable 10 to a rear surface 14 thereof, as can be seen in FIG. 1b. The device 12 is generally in the form of a clip. In this embodiment, the device 12 generally has a “C” shape with two slightly flexible fingers between which a generally circular cavity is defined. The fingers generally define a ring for securing a section of the connection cable 10. The clip has an open end via which the section of the connection cable 10 can be inserted for securing the cable thereat or releasing the connection cable from the clip. When the connection cable 10 is being inserted or released from the clip. Once inserted, the fingers return to a default or closer position such that the connection cable 10 cannot escape from the clip easily.

While in this embodiment the securing device 12 is in the form of a clip, other similar securing devices, such as a notch-like securing device may be used. Similarly, a structure formed into a slot may be provided to a surface of the apparatus. The slot can function similarly to accommodate a section of the connection cable 10 and to secure the connection cable 10 to minimize random movement of the cable or tangling of the cable.

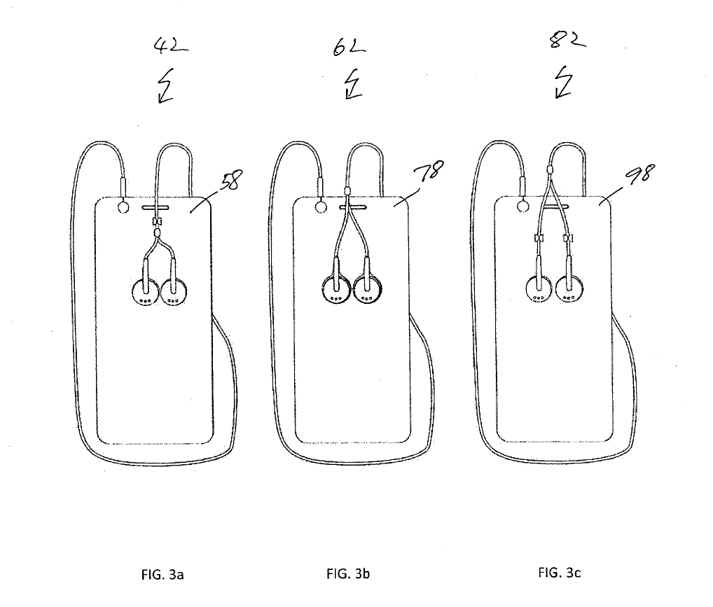

FIG. 2 depicts an apparatus 22 similar to the apparatus 2 in FIG. 1. One main difference between the apparatus 22 and the apparatus 2 is that a similar securing device 34 is provided on a side of the apparatus 22.

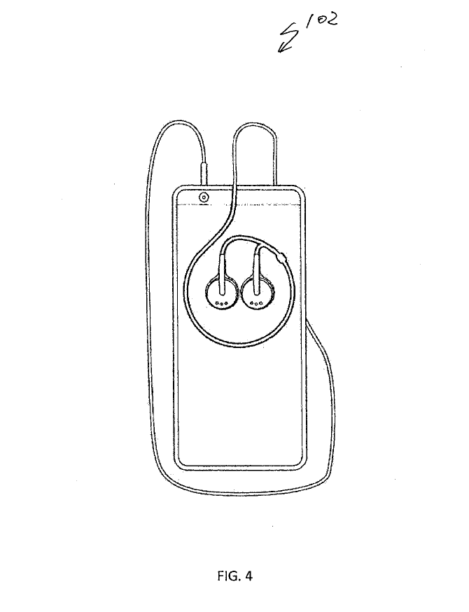

FIG. 3a illustrates an apparatus 42 similar the apparatus 2 in FIG. 1. However, the apparatus 42 is provided with a protective jacket 58 at which a similar securing device is provided. In this embodiment, the securing device likewise adopts a C-shaped structure.

FIGS. 3b and 3c show apparatus 62, 82 similar to the apparatus 42 in FIG. 3a. One main difference of the apparatus 62 is that a similar securing device is located at a top end of the apparatus 62. One main difference of the apparatus 82 is that two securing devices are provided, one for accommodating and securing a section of the connection cable adjacent one earplug and the other for according and securing a section of the connection cable adjacent the other earplug.

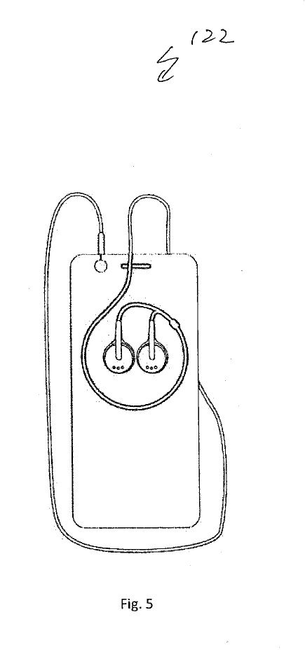

FIG. 4 shows an electronic apparatus 102 with an audio function and in particular a rear side thereof. This apparatus 102 is different in that a cavitation is formed at the rear side. The cavitation is sized and shaped to allow a snap-fit or snap-fit-like engagement between the earplugs and the cavitation. Once snapped fitted to the cavitation, the earplugs are secured thereto. Without a free end, the connection cable is less likely to tangle up. The size and shape of the cavitation however allows removal of the earplugs when an intentional removal 1force is applied to the earplugs.

FIG. 5 shows an electronic apparatus 122 similar the apparatus of FIG. 4. One main difference is that the apparatus 122 is provided with a protective case at which the cavitation is provided. In use, a pair of earplugs is secured to the cavitation of the protective case and not directly to the apparatus 122.

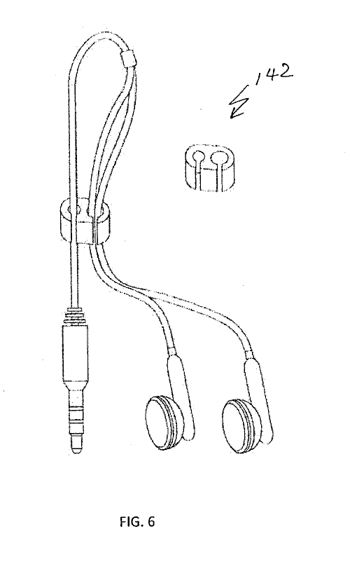

FIG. 6 shows an embodiment of a securing device 142 for securing a section of a connection cable. The securing device is structured to define a C-shaped wall with two outer fingers 144, 146 although a further dividing wall or finger 148 is situated between the two outer fingers. It can be seen in FIG. 6 that two cavities are provided and defined by the two outer fingers and the middle finger. One of the two cavities are smaller and is sized and shaped to accommodate one section of the connection cable, while the other cavity is larger and is sized and shaped to accommodate two sections of the connection cable leading to and adjacent to the earplugs.

The present invention as depicted in the above embodiments demonstrates a convenient way of managing connection cables in an electronic audio device. It can be appreciated that the use of winding system is avoided so as to minimize the chance of damaging the earplugs in the event of over winding.

It should be understood that the above only describes the preferred embodiments according to the present invention, and that modifications and alterations may be made thereto without departing from the spirit of the invention.

1. An electronic apparatus comprising a main body, an ear phone and a connection cable with a substantial length for connecting the ear phone to the main body, wherein the apparatus further comprises a device to releasably secure the ear phone and/or the connection cable to the apparatus to minimize the connection cable from tangling up, and wherein the securing device includes i) a mounting means having a surrounding wall defining a first cavity with a width slightly larger than the width of the connection cable for releasably mounting a section of the connection cable to the apparatus and/or ii) a recess for releasably securing the ear phone to the apparatus.

2. An apparatus as claimed in claim 1, wherein part of the surrounding wall takes the form of a flexible or resilient finger which, in use, is adapted to flex slightly to facilitate the section of the connection cable entering or exiting from the first cavity.

3. An apparatus as claimed in claim 2, wherein the mounting means is, or is alternatively, provided with a surrounding wall defining a second cavity with a width large enough to accommodate two sections of the connection cable.

4. An apparatus as claimed in claim 3, where the first and second cavities are adjacent each other and separated by a divider.

5. An apparatus as claimed in claim 1, wherein the securing device takes the form of a C-shape structure, a notch-like structure or a slot structure.

6. An apparatus as claimed in claim 5, wherein the structure is protruded from a side of the apparatus.

7. An apparatus as claimed in claim 5, wherein the structure is recessed into a side of the apparatus.

8. An apparatus as claimed in claim 1, wherein the securing device is provided on a surface of the apparatus.

9. An apparatus as claimed in claim 1, wherein the apparatus further comprises a protective cover or a casing and the securing device is provided on a surface of the cover or the casing.

10. An apparatus as claimed in claim 1, wherein the recess is sized and shaped to provide a tight fit to accommodate ends of the earphone for releasably securing the earphone to the apparatus.

11. An apparatus as claimed in claim 10, wherein the recess is provided on a surface of the apparatus.

12. An apparatus as claimed in claim 10, wherein the apparatus further comprises a cover or a casing and the securing device is provided on a surface of the cover or the casing.

13. An apparatus as claimed in claim 10, wherein the recess is configured to form an indentation or a cavitation provided on a rear surface of the apparatus.
